(19) United States
(12) Patent Application Publication
(10) Pub. No.: US 2025/0125594 A1
(43) Pub. Date: Apr. 17, 2025

(54) Switchgear

(71) Applicant: ABB Schweiz AG, Baden (CH)

(72) Inventors: Ondrej Novak, Velké Pavlovice (CZ); Dalibor Kopp, Brno (CZ)

(73) Assignee: ABB Schweiz AG, Baden (CH)

(21) Appl. No.: 18/911,391

(22) Filed: Oct. 10, 2024

(30) Foreign Application Priority Data
Oct. 13, 2023 (EP) 23203556.8

(51) Int. Cl. H02B 1/56; H02B 13/00

(52) U.S. Cl. CPC H02B 1/56; H02B 13/00

(57) ABSTRACT

A low voltage, medium voltage or high voltage switchgear, includes a first component; and an air guide structure comprising a plurality of guiding vanes; wherein the plurality of guiding vanes are located adjacent to the first component; and wherein one or more of the plurality of guiding vanes are configured to direct air to enter the air guide structure at an entrance then flow tangentially to a first surface of the first component and then leave the air guide structure at an exit.

### CROSS-REFERENCE TO RELATED APPLICATIONS

The instant application claims priority to European Patent Application No. 23203556.8, filed Oct. 13, 2023, which is incorporated herein in its entirety by reference.

### FIELD OF THE DISCLOSURE

The present disclosure generally relates to improved cooling of components in a low voltage, medium voltage or high voltage switchgear.

### BACKGROUND OF THE INVENTION

In the low, medium and high voltage applications, components that carry current such as bus bars heat up due to the passage of electrical current via Joule heating. These hot components must be cooled. A significant percentage of the cooling is sought to be achieved by air flowing over a surface of a hot component. Therefore, the ability to cool component is directly dependent upon the quantity and quality of the air flowing around the components.

In many cases hot components are not ideally positioned relative to an airflow vector in a given location, causing flow separation. Such a phenomenon causes airflow to circulate around hot parts or to avoid a hot component completely, negatively affecting the cooling performance.

FIG. 1 shows an example of how air cannot follow an abrupt change in direction forced by a hot component, leading to flow separation. Such separation causes boundary layer detachment, formation of reverse flow and recirculation, decreasing cooling ability of air. In FIG. 1 the two hot components are bus bars 10, 20 separated by air, but the rising air does not flow between the two hot components, with airflow separation occurring and leading to inefficient air based cooling.

In most cases the shape of such components cannot be easily modified, because the components often have shapes that serve purposes other than a shape that would be more optimum for cooling.

### BRIEF SUMMARY OF THE INVENTION

The present disclosure generally describes systems and methods that provide an improved ability to cool hot components in a switchgear using air. In a first aspect, there is provided a low voltage, medium voltage or high voltage switchgear, comprising: a first component; and an air guide structure comprising a plurality of guiding vanes.

The plurality of guiding vanes are located adjacent to the first component. One or more of the plurality of guiding vanes are configured to direct air to enter the air guide structure at an entrance then flow tangentially to a first surface of the first component and then leave the air guide structure at an exit.

### BRIEF DESCRIPTION OF THE SEVERAL VIEWS OF THE DRAWING(S)

FIG. 1 shows a representation of airflow around hot components and airflow separation.

FIG. 2 shows a representation of a new air guiding structure located around hot components.

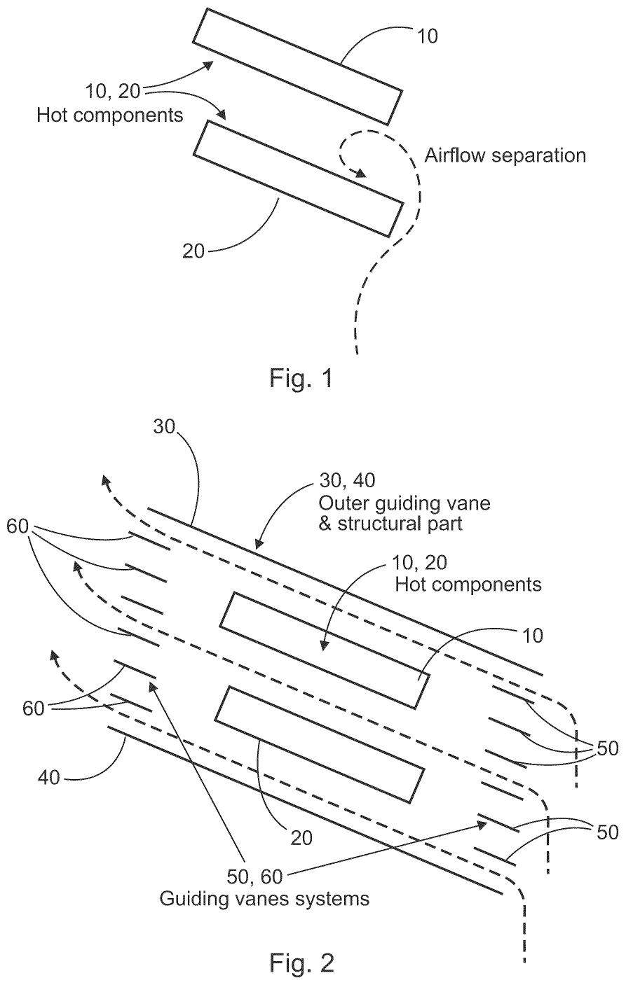

### DETAILED DESCRIPTION OF THE INVENTION

FIG. 2 relates to a new air guiding structure that is located around one or more hot components in a compartment of a switchgear. An exemplar new low voltage, medium voltage or high voltage switchgear comprises: a first component 10; and an air guide structure comprising a plurality of guiding vanes 30, 40, 50, 60. The plurality of guiding vanes are located adjacent to the first component. One or more of the plurality of guiding vanes are configured to direct air to enter the air guide structure at an entrance then flow tangentially to a first surface of the first component and then leave the air guide structure at an exit.

In an example, the first component is a bus bar. In an example, the first component is not oriented horizontally or vertically, but is at an angle. In an example, one or more of the plurality of guiding vanes are parallel to the first surface of the first component.

In an example, the first surface of the first component is flat. In an example, one or more of the plurality of guiding vanes are configured to direct air to enter the air guide structure at the entrance then flow tangentially to a second surface of the first component and then leave the air guide structure at the exit.

In an example, the second surface of the first component is flat. In an example, the second surface of the first component is parallel to the first surface of the first component. In an example, one or more of the plurality of guiding vanes are parallel to the second surface of the first component.

In an example, switchgear comprises a second component 20 disposed adjacent to the first component. The plurality of guiding vanes are located adjacent to the second component. One or more of the plurality of guiding vanes are configured to direct air to enter the air guide structure at the entrance then flow tangentially to a first surface of the second component and then leave the air guide structure at the exit.

In an example, the second component is a bus bar. In an example, the first component is adjacent to and parallel to the second component, for example two bus bars one above the other with an air gap between them. In an example, the second component is not oriented horizontally or vertically, but is at an angle. In an example, one or more of the plurality of guiding vanes are parallel to the first surface of the second component.

In an example, the first surface of the second component is flat.

In an example, one or more of the plurality of guiding vanes are configured to direct air to enter the air guide structure at the entrance then flow tangentially to a second surface of the second component and then leave the air guide structure at the exit.

In an example, the second surface of the second component is flat.

In an example, the second surface of the second component is parallel to the first surface of the first component. In an example, one or more of the plurality of guiding vanes are parallel to the second surface of the second component. In an example, the second component is parallel to the first component;

In an example, the plurality of guiding vanes comprises an upper outer guiding vane 30 located above the first component, and the upper outer guiding vane extends from the entrance of the guide structure to the exit of the air guide structure. In an example, the upper outer guiding vane is located above the second component. In an example, the plurality of guiding vanes comprises a lower outer guiding vane 40 located below the first component, and the lower outer guiding vane extends from the entrance of the guide structure to the exit of the air guide structure.

In an example, the lower outer guiding vane is located below the second component.

In an example, the plurality of guiding vanes comprises one or more front guiding vanes 50 located at the entrance of the air guide structure.

In an example, the one or more front guiding vanes comprises a plurality of front guiding vanes, and a honey comb structure is formed at least in part from the plurality of front guiding vanes.

In an example, the plurality of guiding vanes comprises one or more rear guiding vanes 60 located at the exit of the air guide structure.

In an example, the one or more rear guiding vanes comprises a plurality of rear guiding vanes, and a honey comb structure is formed at least in part from the plurality of rear guiding vanes.

In an example, one or more of the plurality of guiding vanes are flat plates.

In an example, one or more of the plurality of guiding vanes are airfoils.

In an example, the airfoils are non-cambered airfoils.

In an example, the airfoils are heavily-cambered airfoils.

In an example, the plurality of guiding vanes are formed from an insulating material.

In an example, the plurality of guiding vanes are formed from plastic.

In an example, the air directed into the air guide structure come from outside of a compartment within which the components to be cooled are located and is directed out of the compartment after passing through the air guide structure. Thus, not only are the hot components cooled, but the interior of the compartment as a whole is cooled.

Thus, the new development provides for improved cooling of components inside a bus bar space of low, medium or high-voltage applications.

Conductors inside the switchgear generate heat when conducting current, and the new development provides for improved air cooling of these components. In particular, the conducting parts in a bus bar compartment in a traditional switchgear design are relatively difficult to cool because of their shape and position inside the bus bar compartment. Their shape often causes flow separation that decreases the cooling ability. The shape of the bus bar compartment itself causes major flow separations, flow oscillations and disrupts steady flow of air and thus reducing cooling even further. However, the new development enables the bus bars to be cooled by air.

The new development relates to the use of a system of guiding vanes inside an aerodynamic cover. Such a system corrects an air velocity vector to make it become tangential to a hot component surface and forces air to efficiently utilize the surface of hot part to maximize cooling.

The aerodynamic cover is formed in part from upper 30 and lower 40 guiding vanes, and the vanes inside this cover are guiding vanes 50 at the front of the cover and guiding vanes 60 at the rear of the cover.

The inner guiding vanes 50, 60 are optimized to effectively correct the airflow velocity vector, but their shape can vary from simple flat plates, non-cambered airfoils to heavily cambered airfoils. The inner guiding vanes 50, 60 can also be oriented into a honey-comb shaped system to boost structural strength. It is good practice to also create fillets on the leading and trailing edges of the inner vanes and the outer vanes.

Thus, through the new development cooling effectiveness can be significantly improved by adding air flow guiding vane system onto existing bus bar designs to guide air to flow with low angle of attack relative to conductors in the bus bar compartment.

In a specific embodiment, a system of outer and inner guiding vanes are attached to and/or spaced around hot components in the bus bar compartment. These guiding vanes correct the air flow vector and prevent air flow separation. This system also promotes steady air flow into and out of the bus bar compartment. Subsequent improvement in cooling allows designers to use less of expansive materials like copper, providing significant economic benefit.

It is also good practice to create the system from plastic or another insulating material, in order to avoid di-electric phenomena.

The improved cooling means that components, such as bus bars, can be made from less copper, providing economic advantages.

In an example, the first component is a bus bar. In an example, the first component is not oriented horizontally or vertically, but is at an angle. In an example, one or more of the plurality of guiding vanes are parallel to the first surface of the first component.

In an example, the first surface of the first component is flat. In an example, one or more of the plurality of guiding vanes are configured to direct air to enter the air guide structure at the entrance then flow tangentially to a second surface of the first component and then leave the air guide structure at the exit.

In an example, the second surface of the first component is flat. In an example, the second surface of the first component is parallel to the first surface of the first component. In an example, one or more of the plurality of guiding vanes are parallel to the second surface of the first component.

In an example, switchgear comprises a second component that is disposed adjacent to the first component. The plurality of guiding vanes are located adjacent to the second component. One or more of the plurality of guiding vanes are configured to direct air to enter the air guide structure at the entrance then flow tangentially to a first surface of the second component and then leave the air guide structure at the exit.

In an example, the second component is a bus bar. In an example, the first component is adjacent to and parallel to the second component, for example two bus bars one above the other with an air gap between them.

In an example, the second component is not oriented horizontally or vertically, but is at an angle. In an example, one or more of the plurality of guiding vanes are parallel to the first surface of the second component.

In an example, the first surface of the second component is flat.

In an example, one or more of the plurality of guiding vanes are configured to direct air to enter the air guide structure at the entrance then flow tangentially to a second surface of the second component and then leave the air guide structure at the exit.

In an example, the second surface of the second component is flat.

In an example, the second surface of the second component is parallel to the first surface of the first component.

In an example, one or more of the plurality of guiding vanes are parallel to the second surface of the second component.

In an example, the second component is parallel to the first component;

In an example, the plurality of guiding vanes comprises an upper outer guiding vane located above the first component, and the upper outer guiding vane extends from the entrance of the guide structure to the exit of the air guide structure.

In an example, the upper outer guiding vane is located above the second component.

In an example, the plurality of guiding vanes comprises a lower outer guiding vane located below the first component, and the lower outer guiding vane extends from the entrance of the guide structure to the exit of the air guide structure.

In an example, the lower outer guiding vane is located below the second component.

In an example, the plurality of guiding vanes comprises one or more front guiding vanes located at the entrance of the air guide structure.

In an example, the one or more front guiding vanes comprises a plurality of front guiding vanes, and a honey comb structure is formed at least in part from the plurality of front guiding vanes.

In an example, the plurality of guiding vanes comprises one or more rear guiding vanes located at the exit of the air guide structure.

In an example, the one or more rear guiding vanes comprises a plurality of rear guiding vanes, and a honey comb structure is formed at least in part from the plurality of rear guiding vanes.

In an example, one or more of the plurality of guiding vanes are flat plates.

In an example, one or more of the plurality of guiding vanes are airfoils.

In an example, the airfoils are non-cambered airfoils.

In an example, the airfoils are heavily-cambered airfoils.

In an example, the plurality of guiding vanes are formed from an insulating material.

In an example, the plurality of guiding vanes are formed from plastic.

The above aspect and examples will become apparent from and be elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A low voltage, medium voltage or high voltage switchgear, comprising:
a first component; and
an air guide structure comprising a plurality of guiding vanes;
wherein the plurality of guiding vanes are located adjacent to the first component; and
wherein one or more of the plurality of guiding vanes are configured to direct air to enter the air guide structure at an entrance then flow tangentially to a first surface of the first component and then leave the air guide structure at an exit.

2. The switchgear according to claim 1, wherein the first surface of the first component is flat.

3. The switchgear according to claim 1, further comprising:
a second component;
wherein the second component is adjacent to the first component;
wherein the plurality of guiding vanes are located adjacent to the second component; and
wherein one or more of the plurality of guiding vanes are configured to direct air to enter the air guide structure at the entrance then flow tangentially to a first surface of the second component and then leave the air guide structure at the exit.

4. The switchgear according to claim 3, wherein the first surface of the second component is flat.

5. The switchgear according to claim 4, wherein the second component is parallel to the first component.

6. The switchgear according claim 1, wherein the plurality of guiding vanes comprises an upper outer guiding vane located above the first component, and wherein the upper outer guiding vane extends from the entrance of the guide structure to the exit of the air guide structure.

7. The switchgear according to claim 3, wherein the upper outer guiding vane is located above the second component.

8. The switchgear according to claim 3, wherein the plurality of guiding vanes comprises a lower outer guiding vane located below the first component, and wherein the lower outer guiding vane extends from the entrance of the guide structure to the exit of the air guide structure.

9. The switchgear according to claim 8, wherein the lower outer guiding vane is located below a second component.

10. The switchgear according to claim 1, wherein the plurality of guiding vanes comprises one or more front guiding vanes located at the entrance of the air guide structure.

11. The switchgear according to claim 10, wherein the one or more front guiding vanes comprises a plurality of front guiding vanes, and wherein a honey comb structure is formed at least in part from the plurality of front guiding vanes.

12. The switchgear according claim 1, wherein the plurality of guiding vanes comprises one or more rear guiding vanes located at the exit of the air guide structure.

13. The switchgear according to claim 12, wherein the one or more rear guiding vanes comprises a plurality of rear guiding vanes, and wherein a honey comb structure is formed at least in part from the plurality of rear guiding vanes.

14. The switchgear according to claim 1, wherein one or more of the plurality of guiding vanes are flat plates.

15. The switchgear according to claim 1, wherein one or more of the plurality of guiding vanes are airfoils.
